(19) United States
(12) Patent Application Publication
(10) Pub. No.: US 2026/0113087 A1
(43) Pub. Date: Apr. 23, 2026

(54) SYSTEMS AND METHODS FOR TRANSMITTING MULTIPLE BEAMS FROM A SINGLE ANTENNA APERTURE

(71) Applicant: BAE Systems Space & Mission Systems Inc., Broomfield, CO (US)

(72) Inventors: Gary Alexander James Raney, Broomfield, CO (US); Raymond Lloyd Lovestead, Lafayette, CO (US)

(73) Assignee: BAE Systems Space & Mission Systems Inc., Broomfield, CO (US)

(21) Appl. No.: 19/360,602

(22) Filed: Oct. 16, 2025

Related U.S. Application Data
(60) Provisional application No. 63/709,814, filed on Oct. 21, 2024.

(51) Int. Cl. H04B 7/06; H04B 7/0456

(52) U.S. Cl. CPC H04B 7/0617; H04B 7/0465

(57) ABSTRACT

Phased array antenna systems and methods implemented in connection with a beam former enabling multiple signals to be transmitted from a single phased array antenna are provided. The beam former includes at least one beam former unit for each element of the phased array antenna. In a two beam implementation, each beam former unit includes a first input terminal, a first amplifier, a second input terminal, a second amplifier, and an asymmetric combiner having a first input connected to an output of the first amplifier, a second input connected to an output of the second amplifier, and an output connected to the antenna element. An amount of loss imparted to a first signal passed from the first input to the output is less than an amount of loss imparted to a second signal passed from the second input to the output.

### CROSS-REFERENCE TO RELATED APPLICATION

This application claims the benefit of U.S. Provisional Patent Application Ser. No. 63/709,814, filed Oct. 21, 2024, the entire disclosure of which is hereby incorporated herein by reference.

### FIELD

The present disclosure is directed to systems and methods for simultaneously transmitting multiple beams from a single phased array antenna aperture. In at least some embodiments, a first beam is used to transmit a first signal at a relatively high power level while a second beam is used to transmit a second signal at a relatively low power level.

### BACKGROUND

Radio frequency (RF) communication links can be used to provide connectivity over long distances and to mobile platforms. In order to send and receive RF signals, various antenna types, including phased array antennas, have been developed. An advantage of phased array antennas is the ability to steer a beam electronically. In a typical phased array antenna, radiating elements are arranged in a two-dimensional array. Phased array antenna systems have a variety of applications. For example, phased array antenna systems can be used in fifth generation 5G cellular communications system networks. As another example, phased array antenna systems can be used in satellite communication systems.

Satellite communication systems are capable of providing connectivity over large areas of the Earth. A satellite placed in a geostationary Earth orbit (GEO) (i.e. at an altitude of about 35,786 km above the equator) has a fixed position in the sky. This allows for communications between the satellite and fixed antennas on the surface of the Earth. In addition, a GEO satellite can provide a wide coverage area. However, because of the high altitude of a satellite at GEO, a relatively high-powered transmitter is required when sending signals to the satellite from at or relatively near the surface of the Earth (i.e. at an altitude of less than 45 km). In addition, even though a satellite at GEO has a fixed position relative to the surface of the Earth, a tracking mechanism, such as may be provided by a phased array antenna, is required where the transmitter is carried by a mobile platform. A satellite placed at a lower orbit, such as a medium Earth orbit (MEO) (e.g. at an altitude of between about 2000 km and 35,000 km) or a low Earth orbit (LEO) (e.g. at an altitude of between about 160 km and 2000 km) moves across the sky, with the velocity of the relative motion greater for satellites at lower altitudes. Accordingly, even a transceiver at a fixed location on the surface of the Earth requires a tracking mechanism in order to communicate with a satellite at MEO or LEO. In addition, for a given beamwidth, the coverage area of a satellite at MEO or LEO is less than that of a satellite at GEO. However, the latency of transmissions between transceivers at or near the surface of the Earth and a satellite at MEO or LEO is less than that of such transceivers and a satellite at GEO. In addition, the amount of power required to transmit a signal from a transceiver at or near the surface of the Earth to a satellite at MEO or GEO is less than that of such transceivers and a satellite at GEO.

In any communication system, reliable connectivity and high levels of throughput are desired. In connection with a satellite communication system, such attributes can be achieved by providing a communication endpoint capable of communicating with multiple satellites simultaneously. Currently, supporting multiple endpoints requires the use of multiple antennas. Accordingly, the ability of existing systems to support simultaneous transmission of different communication signals to different satellite endpoints has been limited.

### SUMMARY

Embodiments of the present disclosure are directed to systems and methods for transmitting signals over multiple communication channels from a single phased array antenna of a transmitting communication endpoint to multiple receiving communication endpoints. Moreover, the receiving communication endpoints can have different requirements regarding the signal strength of a signal transmitted from the transmitting communication endpoint. For instance, the receiving communication endpoints can be at different distances from the transmitting communication endpoint. As a particular example, the transmitting communication endpoint can be at or near the surface of the Earth, a first one of the receiving communication endpoints can include a satellite communication endpoint at GEO, and a second one of the receiving communication endpoints can include a satellite communication endpoint at LEO.

A system in accordance with embodiments of the present disclosure includes at least two transmitters, a beam former, a feed network, and a phased array antenna having a plurality of antenna elements. Each transmitter in the at least two transmitters operates to modulate a communication signal provided to the transmitter from an interconnected communication source. The beam former receives the communication signals provided by the transmitters, and combines the different communication signals into a combined signal. More particularly, the beam former includes a plurality of beam former units, and in particular includes one beam former unit for each element of the phased array antenna. Each beam former unit includes at least two channels, one for each of the at least two transmitters. The channels each include an input for receiving a signal from one of the transmitters and an amplifier. In accordance with at least some embodiments of the present disclosure, each channel also includes a phase shifter. In addition, each beam former unit includes an asymmetric combiner with at least two inputs, with the first input connected to a terminal end of the first channel and the second input connected to a terminal end of the second channel. An output of the asymmetric combiner is connected to a corresponding element of the phased array antenna by a feed line.

A method in accordance with embodiments of the present disclosure allows multiple independent antenna beams to be transmitted from a single phased array antenna. The method includes providing a modulated first signal to a first input or set of inputs of a beam former and providing a modulated second signal to a second input or set of inputs of the beam former. In accordance with embodiments of the present disclosure, the first signal has a first power or amplitude requirement, and the second signal has a second power or amplitude requirement, where the first power requirement is greater than the second power requirement. The method further includes, for each of a plurality of elements included in the phased array antenna: shifting (e.g. delaying) a phase of the first signal by an amount selected for the first signal and the array antenna element; amplifying the first signal; providing the phase shifted and amplified first signal to a first input of an asymmetric combiner; shifting (e.g. delaying) a phase of the second signal by an amount selected for the second signal and the array antenna element; amplifying the second signal; providing the phase shifted and amplified second signal to a second input of the asymmetric combiner; and providing a combined signal from an output of the asymmetric combiner to the array antenna element. As an example, the first signal can be directed to a first satellite in a geostationary Earth orbit, and the second signal can be directed to a second satellite in a low Earth orbit.

Additional features and advantages of embodiments of the disclosed systems and methods will become more readily apparent from the following description, particularly when taken together with the accompanying drawings.

### BRIEF DESCRIPTION OF THE DRAWINGS

FIG. 1 depicts phased array antenna systems with beam forming modules in accordance with embodiments of the present disclosure in an exemplary operating environment;

FIG. 2 is a block diagram depicting components of a phased array antenna with a beam former in accordance with embodiments of the present disclosure;

FIG. 3 depicts a phased array antenna and a beam former in accordance with embodiments of the present disclosure in a side elevation view;

FIG. 4 depicts aspects of a beam former in accordance with embodiments of the present disclosure;

FIG. 5 depicts aspects of a beam former in accordance with other embodiments of the present disclosure;

FIG. 6 depicts an asymmetric combiner in accordance with embodiments of the present disclosure;

FIG. 7 depicts an asymmetric combiner in accordance with other embodiments of the present disclosure; and

FIG. 8 is a flowchart illustrating aspects of a method for transmitting multiple antenna beams from a single phased array antenna in accordance with embodiments of the present disclosure.

### DETAILED DESCRIPTION

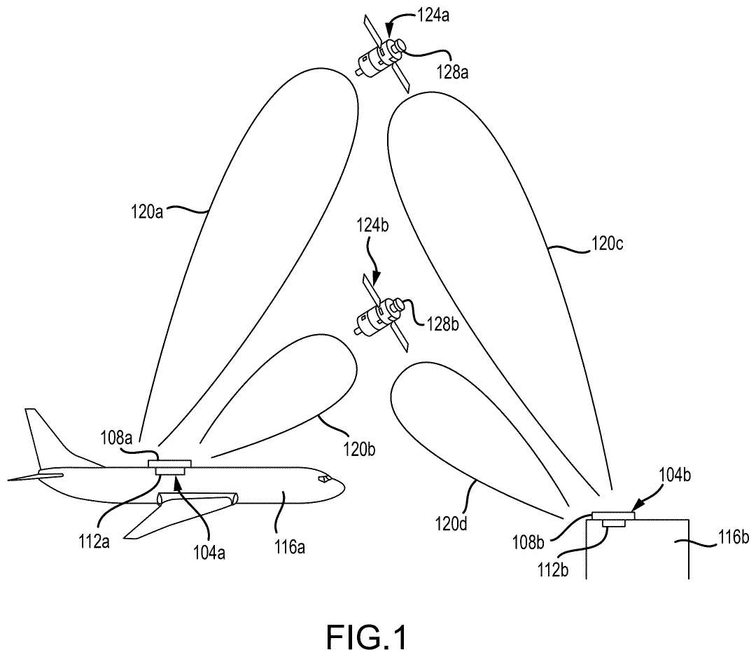

FIG. 1 depicts transmitting communication systems 104, each with a single phased array antenna aperture 108 and a beam forming module 112 in accordance with embodiments of the present disclosure, in an exemplary operating environment. In the illustrated scenario, a first communication system 104a mounted to a first platform 116a is being operated to transmit a first antenna beam 120a to a first communication satellite 124a at a first altitude and to transmit a second antenna beam 120b to a second communication satellite 124b at a second altitude. Also in the illustrated scenario, a second communication system 104b mounted to a second platform 116b is being operated to transmit a third antenna beam 120c to the first communication satellite 124a and to transmit a fourth antenna beam 120d to the second communication satellite 124b at the second altitude. As an example, but without limitation, the first communication satellite 124a can be in an equatorial Earth orbit and the first altitude can be at or about 35,786 km above the equator (i.e. the first satellite 124a can be in a geostationary Earth orbit (GEO)), and the second communication satellite 124b can be in an Earth orbit and the second altitude can be less than 35,000 km above the surface of the Earth (i.e. the second satellite 124b can be in a medium Earth orbit (MEO) of between about 2000 km and about 35,000 km above the surface of the Earth or in a low Earth orbit (LEO) of less than 2000 km above the surface of the Earth.

The first communication satellite 124a can include a first receiving antenna provided as part of a first communication system receiver 128a, while the second communication satellite 124b can include a second receiving antenna provided as part of a second communication system receiver 128b. As can be appreciated by one of skill in the art, for a given gain level at the first 128a and second 128b communication system receivers of the first 124a and second 124b communication satellites respectively, and other parameters being equal, in order to achieve a selected signal-to-noise ratio, the power or amplitude of an antenna beam 120a or 120c transmitted from at or near the surface of the Earth to a communication satellite 124a at GEO must be multiple times greater than the power of an antenna beam 120b or 120d transmitted to a communication satellite 124b at LEO.

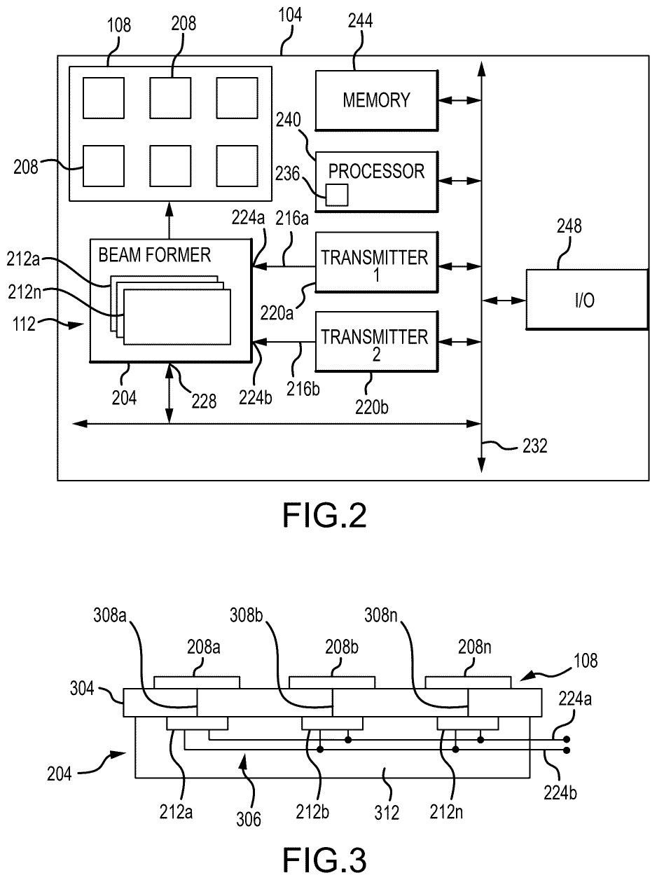

FIG. 2 is a block diagram depicting components of a transmitting communication system 104 including a beam forming module 112 incorporating a beam former 204 in accordance with embodiments of the present disclosure. More particularly, the transmitting communication system 104 includes a phased array antenna 108 that includes a plurality of individual antenna elements 208. As described in greater detail elsewhere herein, the beam former 204 can include a plurality of beam former units 212a-212n. In accordance with embodiments of the present disclosure, one beam former unit 212 is provided for each antenna element 208 included in the phased array antenna 108.

The beam former 204 receives a first input signal 216a from a first transmitter 220a at a first input 224a, and receives a second input signal 216b from a second transmitter 220b at a second input 224b. As can be appreciated by one of skill in the art after consideration of the present disclosure, each transmitter 220 can operate to encode and modulate supplied data for transmission to a receiving endpoint. For example, but without limitation, the receiving endpoint can be in the form of a communication system 128 having a receive antenna carried by a communication satellite 124. Moreover, in accordance with embodiments of the present disclosure, the first signal 216a can be intended for transmission to a first communication system 128a carried by a first communication satellite 124a that is in a geostationary Earth orbit, and the second signal 216b can be intended for transmission to a second communication system 128b carried by a second communication satellite 124b in an orbit that is relatively close to the surface of the Earth, such as a low Earth orbit.

The beam former 204 can also include a control input 228 that is connected to a communication bus 232. The control input 228 can receive instructions, for example generated in connection with the execution of software 236 by a processor 240, related to the operation of the beam former 204, including but not limited to the pointing of antenna beams 120 generated by the communication system 104. Various other components can also be interconnected by the communication bus 232, such as a memory 244 or other structures for the temporary or long-term storage of data, instructions, and the like, and an input/output terminal 248, which can serve to send and receive instructions, data, data for transmission, and the like between the communication system 104 and other systems or devices. In at least one embodiment there are one or more processors or cores of the processor 240 that execute the instructions 236, which can be in the form of firmware.

The instructions 236 control aspects of the operations of the transmitters 220a and 220b and the beam former 204. As examples, the instructions 236 can function to set transmitter 220 parameters, control operation of the transmitters 220, and control the operation of phase shifters included in the beam former 204 in order to steer the beams 120.

FIG. 3 depicts a phased array antenna 108 and an associated beam former 204 in accordance with embodiments of the present disclosure in a side view in elevation. As can be seen in the figure, each element 208a-n of the phased array antenna 108 can be disposed on a first side of an antenna substrate 304, while each beam former unit 212a-n of the beam former 204 can be disposed on a second side of the antenna substrate 304. Input signals 216a and 216b received at the first 224a and the second 224b inputs respectively are provided to each of the beam former units 212a-n by a feed network 306. As described in greater detail elsewhere herein, each beam former unit 212 forms a combined output signal based on the signals 216 received over the first 224a and the second 224b inputs. Accordingly, a single feed line 308a-n extends from each beam former unit 212a-n to an interconnected antenna element 208a-n.Some or all of the components of the beam former 204 can be formed in or on a circuit substrate 312. For example, some or all of the components of the beam former 204 can be formed as part of an integrated circuit, on surfaces and layers of a printed circuit board, as discrete elements disposed on a supporting substrate, or as various combinations thereof.

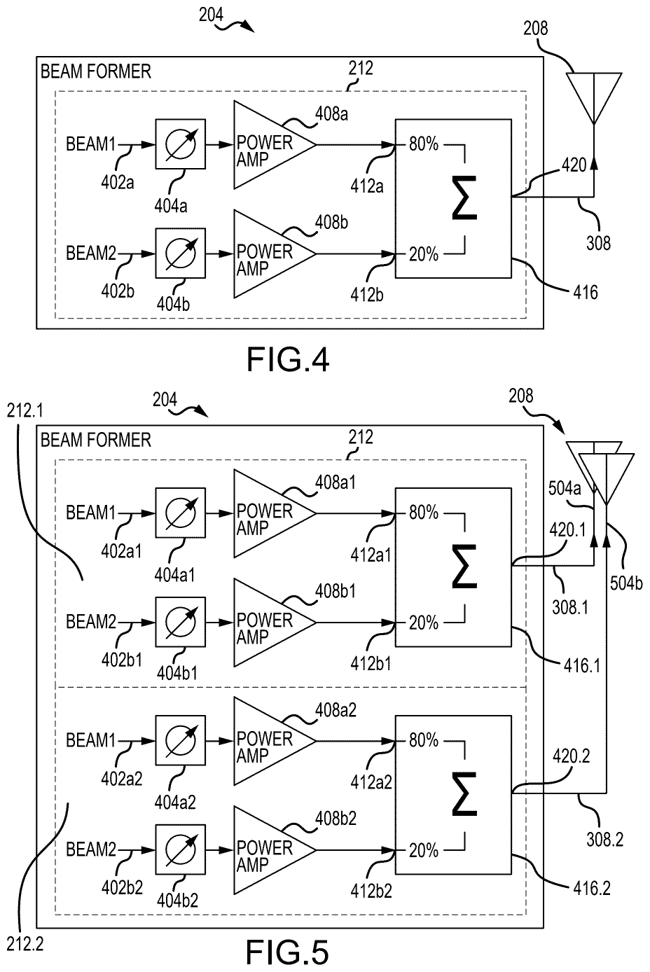

FIG. 4 depicts aspects of a beam former 204 in accordance with embodiments of the present disclosure, and in particular depicts elements of a beam former unit 212 included in the beam former 204. A first beam former unit input 402a of each beam former unit 212 included in a beam former 204 is connected to the first input 224a of the beam former 204 by a feed network 306, and a second beam former unit input 402b of each beam former unit 212 included in the beam former 204 is connected to the second input 224b of the beam former 204 by the feed network 306. In operation, the first input 224a can be used to carry a radio frequency data stream for transmission by the phased array antenna 108 to a first communication system 128a carried by a first communication satellite 124a, while the second input 224b can be used to carry a radio frequency data stream for transmission by the phased array antenna 108 to a second communication system 128b carried by a second communication satellite 124b. As shown in the illustrated embodiment, the first input 402a is connected to a first phase shifter 404a, while the second input 402b is connected to a second phase shifter 404b. As can be appreciated by one of skill in the art after consideration of the present disclosure, the phase shifters 404 can be controlled in connection with steering an antenna beam 120 carrying an associated data stream. As an example, instructions regarding an amount of delay or the like to be imparted on a signal by a phase shifter 404 can be delivered over a communication bus 232 connecting the beam former units 212 to a control algorithm or the like implemented by the processor 240. The output of the first phase shifter 404a is passed to a first power amplifier 408a, and the output of the second phase shifter 404b is passed to a second power amplifier 408b. The output of the first power amplifier 408a is connected to a first input 412a of an asymmetric combiner 416, and the output of the second power amplifier 408b is connected to a second input 412b of the asymmetric combiner 416. The output 420 of the asymmetric combiner 416 is connected to an associated element 208 of the phased array antenna 108 by a single feed line 308. In accordance with embodiments of the present disclosure, the first amplifier 408a can be the same as the second amplifier 408b. Accordingly, the maximum gain of the first amplifier 408a can be equal to the maximum gain of the second amplifier 408b.

As can be appreciated by one of skill in the art after consideration of the present disclosure, where the first communication satellite 124a is in a geosynchronous Earth orbit, and where the second communication satellite 124b is in a low Earth orbit, for a given level of signal power when received at the associated communication systems 128a and 128b, the power of a first antenna beam 120a carrying the first radio frequency data stream as transmitted from the phased array antenna 108 needs to be multiple times greater than the power of a second antenna beam 120b carrying the second radio frequency data stream as transmitted from that same phased array antenna 108. In order to provide such a differential in the power of the transmitted beams 120a and 120b, the first power amplifier 408a can be operated at a higher gain level than the second power amplifier 408b. In addition, and as discussed in greater detail elsewhere herein, the asymmetric combiner 416 can be configured such that an amount of coupling between the first input 412a of the asymmetric combiner 416 and the output 420 of the asymmetric combiner 416 is greater than an amount of coupling between the second input 412b of the asymmetric combiner 416 and the output 420 of the asymmetric combiner 416. Accordingly, the power of the first transmitted beam 120a is greater than the power of the second transmitted beam 120b. In the example illustrated in FIG. 4, the asymmetric combiners 416 of the beam former unit 212 are implemented as sets of strip lines disposed on a printed circuit board, while the other components of the beam former unit 212 are implemented as elements formed as part of an integrated circuit.

FIG. 5 depicts aspects of a beam former 204 in accordance with other embodiments of the present disclosure, and in particular depicts elements of a beam former 204 configured to produce antenna beams 120 having selected polarizations. As can be appreciated by one of skill in the art after consideration of the present disclosure, a phased array antenna 108 supporting beams 120 having selected polarizations can include antenna elements 208 that each have a first feed point 504a on a first side of the antenna element 208 and a second feed point 504b on a second side of the antenna element, where the first side is adjacent to the second side. That is, transmitting an antenna beam 120 with polarization control requires providing separate outputs to each of two feed points 504a and 504b of each antenna element 208. Accordingly, the beam former units 212 in such an embodiment includes a first beam former unit subassembly 212.1 and a second beam former unit subassembly 212.2. Each of the beam former unit subassemblies 212.1 and 212.2 is connected to the first 224a and the second 224b inputs of the beam former 212. In a typical operational scenario, and for a given steering angle, an amount of phase shift imparted by the first beam former unit subassembly 212.1 to signals delivered over the inputs 224 will differ from the amount of phase shift imparted by the second beam former unit subassembly 212.2 to those same signals delivered over the inputs 224. The different phase shift amounts can be realized through control signals generated by a control algorithm or the like executed by the processor 240 and passed to the associated phase shifters 404 over the communication bus 232.

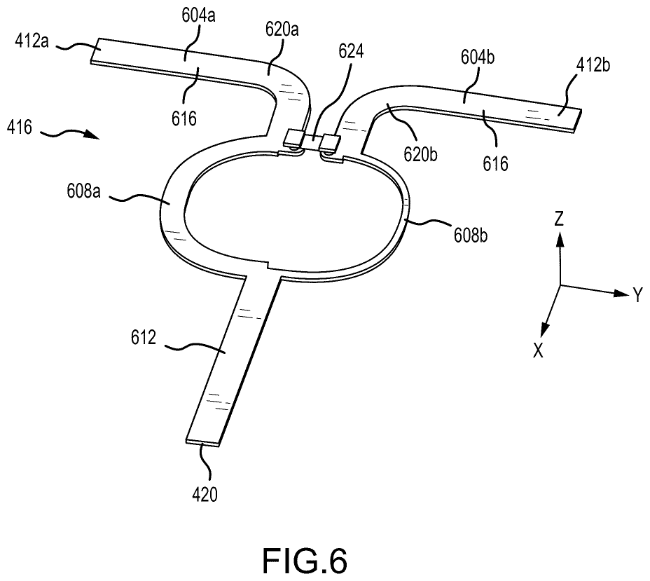

FIG. 6 depicts an asymmetric combiner 416 of a beam former unit 212 (or of a beam former unit subassembly) of a beam former 204 in accordance with embodiments of the present disclosure. As shown in the figure, the asymmetric combiner 416 generally includes a first input line 604a connecting the first input 412a to a first intermediate line 608a, and a second input line 604b connecting the second input 412b to a second intermediate line 608b. The first 608a and second 608b intermediate lines are joined to one another at a common output line 612, which is connected to or forms the output 420 of the asymmetric combiner 416.

In accordance with embodiments of the present disclosure, the first input line 604a and the second input line 604b can include body portions 616 that are disposed along a common line, and that each terminate in a 90° bend portion 620a and 620b respectively. The bend portions 620a and 620b join the input lines 604a and 604b to the respective intermediate lines 608a and 608b. In addition, a resistor element 624 connects the end of the first input line 604a adjacent to the first intermediate line 608a to the end of the second input line 604b adjacent to the second intermediate line 608b. The intermediate lines 608a and 608b can be configured to present a selected impedance to a signal. For instance, the first intermediate line 608a can be configured to have an impedance that is half an impedance of the second intermediate line 608b. In accordance with further embodiments of the present disclosure, a length of each of the first input line 604a, the second input line 604b, and the output line 612 can be equal to or about equal to (where about is less than or equal to +/−10%) a quarter wavelength of carrier signals of the first 120a and the second 120b antenna beams.

In at least some embodiments of a beam former 204 implemented using the asymmetric combiner 416 of FIG. 6, the coupling of the second input 412b is reduced as compared to the second input 412a such that losses experienced by a signal provided to the first input 412a of the asymmetric combiner 416 are about 6 dB less than the losses experienced by a signal provided to the second input 412b of the asymmetric combiner 416 over a wide range of frequencies. In addition, isolation between the signals is relatively high across that range of frequencies. This result is advantageous where the amount of power required or desired for creating the first antenna beam 120a is greater than the amount of power required or desired for creating the second antenna beam 120b. For instance where the first antenna beam 120a is intended for transmitting signals to a communication system 128a on a communication satellite 124a in a geosynchronous Earth orbit, and the second antenna beam 120b is intended for transmitting signals to a communication system 128b on a communications satellite 124b in a low Earth orbit, such a differential in the power of the antenna beams 120a and 120b is appropriate.

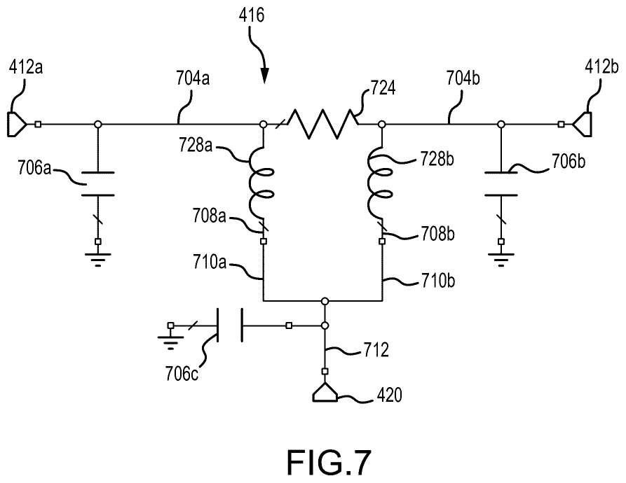

FIG. 7 depicts an asymmetric combiner 416 of a beam former unit 212 (or of a beam former unit subassembly) of a beam former 204 in accordance with other embodiments of the present disclosure. In this example, the asymmetric combiner 416 is depicted and can be implemented as a set of discrete components. The components include a first input line 704a connected to a first port or input 412a and a second input line 704b connected to a second port or input 412b. An end of the first input line 704a opposite the first input 412a is terminated at a junction between a first end of a resistor element 724 and a first end of a first inductor element 728a provided as part of a first intermediate line 708a. An end of the second input line 704b opposite the second input 412b is terminated at a junction between a second end of the resistor element 724 and a first end of a second inductor element 728b provided as part of a second intermediate line 708b. A conductor 710a provided as part of the first intermediate line 708a and extending from a second end of the first inductor element 728a terminates at a junction with a common output line 712. A conductor 710b provided as part of the second intermediate line 708b and extending from a second end of the second inductor element 728b terminates at the junction between the end of the first conductor 710a and the common output line 712. The common output line 712 is in turn connected to the output 420 of the asymmetric combiner 416.

In the illustrated example, a capacitance of the first input line 704a (represented by capacitor 706a) is greater than a capacitance of the second input line 704b (represented by capacitor 706b). For instance, the capacitance of the first input line 704a can be 3 pF while the capacitance of the second input line 704b can be 2 pF. A resistance of the resistor element 724 can be 100 Ohm. An inductance of the first intermediate line 708a is less than an inductance of the second intermediate line 708b. For instance, the inductance of the first intermediate line 708a can be 1 nH while the inductance of the second intermediate line 708b can be 2 nH. A capacitance of the common output line 712 (represented by capacitor 706c) can be 1 pF. In addition, a length of each of the first input line 704a the second input line 704b and the output line 712 can each be equal to or about equal to (where about is less than or equal to +/−10%) a quarter wavelength of carrier signals of the first 120a and the second 120b antenna beams.

The example of a beam former 204 implemented using the asymmetric combiner 416 of FIG. 7 can provide enhanced coupling for a signal provided at the first input 412a as compared to a signal provided at the second input 412b. As a result of this asymmetric coupling, the losses experienced by a signal provided to the first input 412a of the asymmetric combiner 416 can be, for instance, about 5 dB less than the losses experienced by a signal provided to the second input 412b of the asymmetric combiner 416 over a wide range of frequencies. In addition, isolation between the signals is relatively high across that range of frequencies. As in other embodiments, this result is advantageous where the amount of power required or desired for creating the first antenna beam 120a is greater than the amount of power required or desired for creating the second antenna beam 120b. For instance where the first antenna beam 120a is intended for transmitting signals to a communication system 128a on a communication satellite 124a in a geosynchronous Earth orbit, and the second antenna beam 120b is intended for transmitting signals to a communication system 128b on a communications satellite 124b in a low Earth orbit, such a differential in the power of the antenna beams 120a and 120b is appropriate.

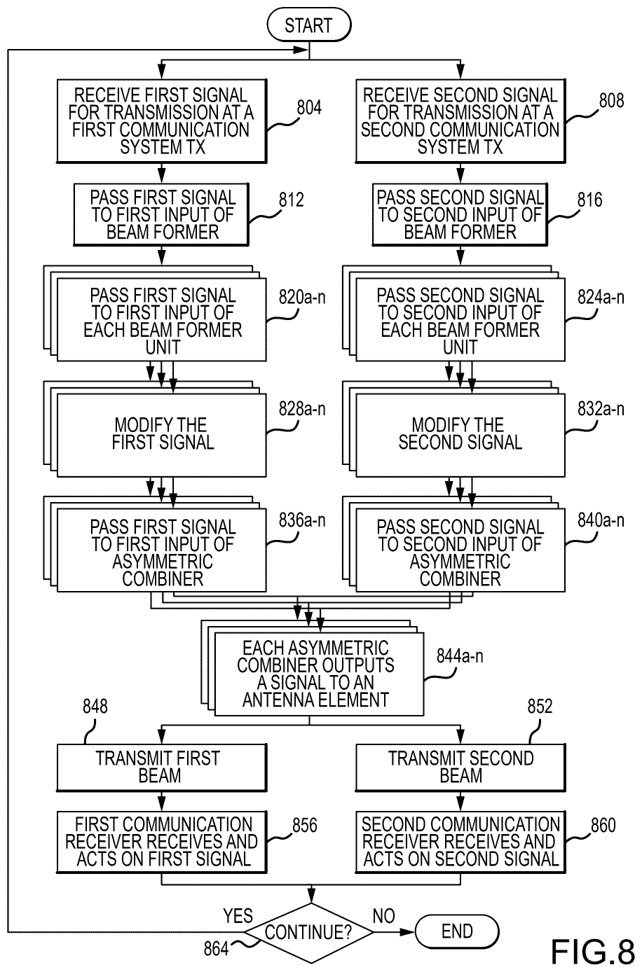

FIG. 8 is a flowchart illustrating aspects of a method for operating a transmitting communication system 104, and in particular for forming multiple antenna beams 120 from a single phased array antenna 108 in accordance with embodiments of the present disclosure. The processing in one embodiment is controlled by one or more processors 240 that execute instructions 236 for the process steps. Initially, first 216a and second 216b signals for transmission to first and second communication system receivers 128a and 128b respectively are separately received at first 220a and second 220b transmitters (steps 804 and 808). As examples, but without limitation, the first communication system receiver 128a may be carried by a first communication satellite 124a in a geosynchronous Earth orbit, while the second communication system receiver 128b may be carried by a second communication satellite 124b in a low Earth orbit.

A modulated first input signal 216a is passed from the first transmitter 220a to a first input 224a of a beam former 204 (step 812) while a modulated second input signal 216b is passed from the second transmitter 220b to a second input 224b of the beam former 204 (step 813). The beam former 204 then passes the modulated first input signal 216a to the first beam former unit inputs 402a of each of the beam former units 212 included in the beam former 204 (step 820a-n, where n is equal to the number of beam former units) and passes the modulated second input signal 216b to the second beam former unit inputs 402b of each of the beam former units 212 included in the beam former 204 (step 824a-n).

Within each beam former unit 212, the first signal 216a is modified (step 828a-n). Modification can include modifying the phase of the first signal 216a through selective control of the first phase shifter 404a. In a typical operating scenario, each beamforming unit 212 will apply a different phase shift to the first signal 216a in order to achieve a desired steering angle of the resulting first antenna beam 120a. Modification can also include amplifying the first signal 216a through selective control of the first amplifier 408a. Where, for example, the first signal 216a is to be transmitted to a communication satellite 124a in a geosynchronous Earth orbit, the first amplifier 408a may be operated at a relatively high gain or amplification level. Each beam former unit 212 also modifies the second signal 216b (step 832a-n). Modification can include modifying the phase of the second signal 216b through selective control of the second phase shifter 404b. In a typical operating scenario, each beamforming unit 212 will apply a different phase shift to the second signal 216b in order to achieve a desired steering angle of the resulting second antenna beam 120b. Modification can also include amplifying the second signal 216b through selective control of the second amplifier 408b. Where, for example, the second signal 216b is to be transmitted to a communication satellite 124b in a low Earth orbit, the second amplifier 408b may be operated at a relatively low gain or amplification level. That is, the second amplifier 408b may be operated at an amplification level that is less than the amplification level at which the first amplifier 408a is operated. For example, but without limitation, the first amplifier 408a can be operated at an amplification level that if four times greater than the amplification level at which the second amplifier 408b is operated.

Within each beam former unit 212, the modified first signal is passed to a first input 412a of an asymmetric combiner 416 (step 836a-n), and the modified second signal is passed to a second input 412b of the asymmetric combiner 416 (step 840a-n). The asymmetric combiner 416 in each beam former unit 212 operates to place the first 216a and second 216b signals on a common signal path, which carries the first 216a and second 216b signals to the antenna element 208 connected to the beam former unit 212 (step 844a-n). In accordance with embodiments of the present disclosure, the asymmetric combiner 416 presents a lower loss signal path to the first input signal 216a than to the second input signal 216b. Again following an example in which the first signal 216a is intended for delivery to a communication system receiver 128a carried by a first communication satellite 124a that is in a geosynchronous Earth orbit, and in which the second signal 216b is intended for delivery to a communication system receiver 128b carried by a second communication satellite 124b that is in a low Earth orbit, providing a lower loss signal path to the first signal 216a than to the second signal 216b can help ensure that the different signal path characteristics are appropriate for their intended uses. The modified first signal 216a from each of the beam former units 212 is then transmitted from the individual antenna elements 208 of the phased array antenna 108 as the first antenna beam 120a (step 848) while the modified second signal 216b from each of the beam former units 212 is transmitted from the individual antenna elements 208 of the phased array antenna 108 as the second antenna beam 120b (step 852). More particularly, the first antenna beam 120a, carrying the first signal 216a, is pointed at the first communication system receiver 128a carried by the first communication satellite 124a, while the second antenna beam 120b, carrying the second signal 216b, is pointed at the second communication system receiver 128b carried by the second communication satellite 124b. Accordingly, embodiments of the present disclosure allow different antenna beams 120 carrying different information streams to be pointed at different receiving communication endpoints to be transmitted simultaneously from a common phased array antenna aperture.

The first communication system receiver 128a can then take action based on or relating to the received first signal 216a (step 856), while the second communication receiver 128b can take action based on or relating to the received second signal 216b (step 860). As examples, but without limitation, further action taken by a communication receiver 128 in response to a received signal 216 can include delivering the signal 216 to a transmitter in order to relay the signal 216 to another communication receiver, delivering the received signal 216 to a system local to the communication receiver 128 for processing, and the like. A decision can next be made as to whether operation of the transmitting communication system 104 should continue (step 864). If operation should continue, the process can return to steps 804 and 808. Otherwise, the process can end.

Accordingly, embodiments of the present disclosure provide systems and methods for transmitting multiple communication signals 216 as part of multiple, independent antenna beams 120, from a single phased array antenna aperture 108. Embodiments of the present disclosure are particularly well-suited for simultaneously transmitting a first antenna beam 120a carrying a first signal 216a to a first communication endpoint 128a and transmitting a second antenna beam 120b carrying a second signal 216b to a second communication endpoint 128b where the power or amplitude requirements for the first 120a and second 120b antenna beams differ. Embodiments of the present disclosure are also well suited to simultaneously transmitting first and 216a and second 216b signals where the sensitivity of the signals 216a and 216b to distortion differ from one another.

For instance, transmitting a signal 216 to a communication system receiver 128b carried by a communication satellite 124b at a relatively low altitude, such as at LEO, requires a much less powerful antenna beam 120a than transmitting a signal 216 to a communication satellite 124a at a relatively high altitude. As a result, the power amplifiers 408b within the beam former units 212 used to amplify the signal 216 directed to the relatively close communication satellite 124b can be operated at a relatively low power, resulting in decreased distortion and enabling the use of more complex waveforms than higher power levels would reliably allow. In addition, in accordance with embodiments of the present disclosure, the asymmetric combiner 416 within each beam former unit 212 is configured so that losses experienced by the first signal 216a between the first input 412a and the output 420 of the asymmetric combiner 416 are significantly lower (e.g. about 5 dB lower) than losses experienced by the second signal 216b when passing between the second input 412b and the output 420 of the asymmetric combiner 416. Also, by providing a beam former 204 in which the same power amplifiers 408 can be used in all of the beamforming units 212 for all of the supported channels, and in which the power amplifiers 408b used in connection with transmission of the second signal 216 can be operated at a gain level that is lower (e.g. at least four times lower) than a maximum gain level, distortion of the second signal 216b can be minimized. This is particularly advantageous when the second signal 216b is transmitted to a communication system receiver 128b using a communication protocol having relatively complex waveforms that are particularly sensitive to distortion errors.

Although various examples discussed herein have been directed to beam formers 204 in which an asymmetric combiner 416 provided for each antenna element 208 of a communication system 104, embodiments of the present disclosure are not limited to communications systems. For instance, radar and electronic warfare systems can be implemented using a beam former 204 incorporating one or more asymmetric combiners 416 as disclosed herein.

The foregoing description has been presented for purposes of illustration and description. Further, the description is not intended to limit the disclosed systems and methods to the forms disclosed herein. Consequently, variations and modifications commensurate with the above teachings, within the skill or knowledge of the relevant art, are within the scope of the present disclosure. The embodiments described hereinabove are further intended to explain the best mode presently known of practicing the disclosed systems and methods, and to enable others skilled in the art to utilize the disclosed systems and methods in such or in other embodiments and with various modifications required by the particular application or use. It is intended that the appended claims be construed to include alternative embodiments to the extent permitted by the prior art.

What is claimed is:

1. A method for transmitting multiple beams from a single phased array antenna, comprising:
receiving a first signal for transmission at an input of a beam former, wherein the first signal has a first power requirement;
receiving a second signal for transmission at a second input of the beam former, wherein the second signal has a second power requirement, and wherein the first power requirement is greater than the second power requirement; and
for each of a plurality of array antenna elements included in the phased array antenna:
shifting a phase of the first signal by an amount selected for the first signal and the array antenna element;
providing the phase shifted first signal to a first input of an asymmetric combiner;
shifting a phase of the second signal by an amount selected for the second signal and the array antenna element;
providing the phase shifted second signal to a second input of the asymmetric combiner; and
providing a combined signal from an output of the asymmetric combiner to the array antenna element.

2. The method of claim 1, further comprising:
amplifying the phase shifted first signal, wherein the phase shifted and amplified first signal is provided to the first input of the asymmetric combiner; and
amplifying the phase shifted second signal, wherein the phase shifted and amplified second signal is provided to the second input of the asymmetric combiner,
wherein the first power requirement is at least four times greater than the second power requirement.

3. The method of claim 1, wherein the first signal for transmission is provided to the first input of the beam former and the second signal for transmission is provided to the second input of the beam former simultaneously.

4. The method of claim 1, wherein the first signal is transmitted from the phased array antenna in a first direction relative to the phased array antenna, and wherein the second signal is transmitted from the phased array antenna in a second direction relative to the phased array antenna.

5. The method of claim 1, wherein a loss imparted to the first signal by the asymmetric combiner is less than a loss imparted to the second signal by the asymmetric combiner.

6. The method of claim 5, wherein the first signal is amplified by a first amount, and wherein the second signal is amplified by the first amount.

7. The method of claim 1, wherein the first signal is transmitted as a first beam at a first power, and wherein the second signal is transmitted as a second beam at a second power.

8. The method of claim 7, wherein the first signal is pointed in a first direction relative to the phased array antenna, and wherein the second signal is pointed in a second direction relative to the phased array antenna.

9. The method of claim 8, wherein first information is encoded in the first signal, and wherein second information is encoded in the second signal.

10. The method of claim 8, wherein the first signal is directed to a first satellite in a geostationary Earth orbit, and wherein the second signal is directed to a second satellite in a low Earth orbit.

11. A system, comprising:
a phased array antenna having a plurality of antenna elements; and
a beam former, including a plurality of beam former units, wherein at least one beam former unit of the plurality of beam former units is provided for each of the antenna elements of the phased array antenna, wherein each beam former unit in the plurality of beam former units includes:
a first beam former input;
a second beam former input; and
an asymmetric combiner, wherein an output of the asymmetric combiner is connected to at least one of the antenna elements.

12. The system of claim 11, wherein each beam former unit further includes:
a first phase shifter, wherein the first phase shifter is located between the first beam former input and a first input of the asymmetric combiner; and
a second phase shifter, wherein the second phase shifter is located between the second beam former input and a second input of the asymmetric combiner.

13. The system of claim 11, wherein each beam former unit further includes:
a first amplifier, wherein the first amplifier is located between the first beam former input and a first input of the asymmetric combiner; and
a second amplifier, wherein the second amplifier is located between the second beam former input and a second input of the asymmetric combiner.

14. The system of claim 12, wherein each beam former unit further includes:
a first amplifier, wherein the first amplifier is located between the first beam former input and a first input of the asymmetric combiner; and
a second amplifier, wherein the second amplifier is located between the second beam former input and a second input of the asymmetric combiner.

15. The system of claim 14, wherein the first phase shifter is located between the first beam former input and an input of the first amplifier, and wherein the second phase shifter is located between the second beam former input and an input of the second amplifier.

16. The system of claim 13, wherein a maximum gain of the first amplifier is about equal to a maximum gain of the second amplifier.

17. The system of claim 11, wherein a loss between a first input of the asymmetric combiner and the output of the asymmetric combiner is about one-quarter a loss between a second input of the asymmetric combiner and the output of the asymmetric combiner.

18. The system of claim 11, wherein the system is a communication system, a radar, or an electronic warfare system.

19. The system of claim 11, wherein a first communication signal for delivery to a satellite at a geostationary Earth orbit is provided to the first beam former input, and wherein a second communication signal for delivery to a satellite at a low Earth orbit is provided to the second beam former input.

20. A communication system, comprising:
a first transmitter;
a second transmitter;
a phased array antenna having a plurality of antenna elements; and
a beam former, including a plurality of beam former units, wherein at least one beam former unit of the plurality of beam former units is provided for each of the antenna elements of the phased array antenna, wherein each beam former unit in the plurality of beam former units includes:
a first input, wherein the first input is interconnected to the first transmitter;
a second input, wherein the second input is interconnected to the second transmitter;
an asymmetric combiner;
a first amplifier, wherein the first input is connected to an input of the first amplifier, and wherein an output of the first amplifier is connected to a first input of the asymmetric combiner;
a second amplifier, wherein the second input is connected to an input of the second amplifier, and wherein an output of the second amplifier is connected to a second input of the asymmetric combiner; and
a feed line, wherein the feed line connects an output of the asymmetric combiner to one of the antenna elements.
